(19) United States
(12) Patent Application Publication
(10) Pub. No.: US 2010/0127977 A1
(43) Pub. Date: May 27, 2010

(54) POINTING DEVICE, ELECTRONIC DEVICE AND OPERATION METHOD THEREOF

(76) Inventors: Peng-Hsiang SUNG, Taipei City (TW); Yi-Hung SHEN, Taipei City (TW); Jen-Yand HO, Taipei City (TW)

Correspondence Address: Muncy, Geissler, Olds & Lowe, PLLC, 4000 Legato Road, Suite 310, FAIRFAX, VA, 22033, US

(21) Appl. No.: 12/625,110

(22) Filed: Nov. 24, 2009

Related U.S. Application Data
(60) Provisional application No. 61/117,580, filed on Nov. 25, 2008.

(51) Int. Cl. G09G 5/08

(52) U.S. Cl. 345/157

(57) ABSTRACT

An operation method for a pointing device includes steps as follows. A present mode is provided. The present mode is set to a first mode, in which a cursor is displayed on a screen. The cursor is moved according to a control signal from the pointing device. When a switch signal is received, the present mode is set to a second mode, in which a selection bar is displayed on the screen. An operation of several arrow keys is simulated according to the control signal, such that the selection bar is moved according to the simulated operation.

### CROSS-REFERENCE TO RELATED APPLICATION

This application claims the priority benefit of U.S. Provisional Application Ser. No. 61/117,580, filed Nov. 25, 2008, the full disclosures of which are incorporated herein by reference.

### BACKGROUND

1. Technical Field

The present disclosure relates to an electronic device. More particularly, the present disclosure relates to a pointing device.

2. Description of Related Art

In a graphical user interface, pointing devices are more preferred than keyboards. Among all kinds of pointing devices, mice are the most popular pointing devices. A user could use the mouse to control a cursor displayed on the screen to move and to select an icon on the screen.

As electronic devices become thinner, many kinds of pointing devices with smaller size are developed to replace the mice. The smaller pointing devices may be touchpads, trackballs, optical finger navigation devices and etc. However, the using methods for the above smaller pointing devices are quite different from the using method for the mice. Those that have been used to the mice would not get used to the smaller pointing devices easily. Therefore, whether a mobile device has the smaller pointing device or not, they often carry an extra mouse with the mobile device. It is really inconvenient.

### SUMMARY

An operation method for a pointing device is provided. The operation method has several steps as follows. A present mode is provided. An element of the pointing device may determine whether a switch signal is received. When the switch signal is not received, the present mode is set to a first mode, wherein a cursor is displayed on a screen in the first mode. In the first mode, the cursor is moved according to a control signal generated from the pointing device. When the switch signal is received, the present mode is set to a second mode, wherein a selection bar is displayed on the screen in the second mode. In the second mode, an operation of a plurality of arrow keys is simulated to move the selection bar according to the control signal.

In another embodiment of this invention, an electronic device is provided. The electronic device has a screen, a pointing device and a processing module. The pointing device generates a control signal. The processing module determines a present mode as a first mode or a second mode. When the present mode is the first mode, the processing module moves a cursor displayed on the screen according to the control signal. When the present mode is the second mode, the processing module simulates an operation of several arrow keys to move a selection bar displayed on the screen according to the control signal.

In another embodiment of this invention, an operation method for a pointing device of an electronic device is provided. The electronic device has a screen, a processing module, a pointing device and an arrow-control key set below the pointing device. The operation method has several steps as follows. A first mode is executed. When the pointing device receives the control signal, a cursor displayed on the screen is moved according to a control signal in the first mode. When the pointing device receives a continuous pressing signal, the arrow-control key is triggered off to generate a switch signal. The switch signal is forwarded to the processing module. The processing module switches the first mode to a second mode accordingly. The control signal is converted to a scan code to move a selection bar within several preset bars on the screen in the second mode.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a functional block diagram of an electronic device with a pointing device according to one embodiment of this invention;

FIG. 2 is a front view of the screen of FIG. 1 in a first mode;

FIG. 3 is a front view of the screen of FIG. 1 in a second mode; and

FIG. 4 is a flowchart of an operation method for a pointing device according to another embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

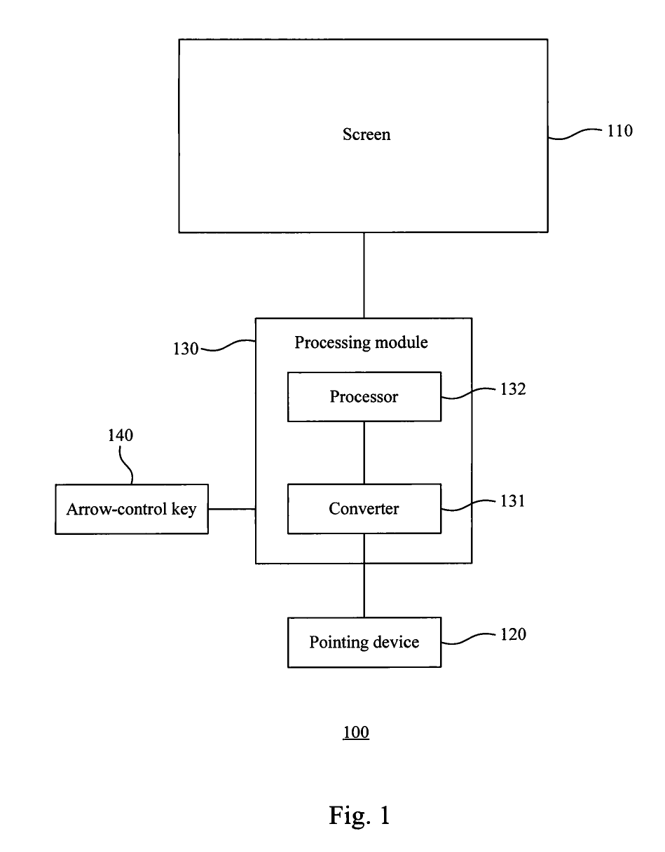

FIG. 1 is a functional block diagram of an electronic device with a pointing device according to one embodiment of this invention. The electronic device with a pointing device could provide several operational modes. For example, in a first mode, a cursor may be displayed on a screen of the electronic device and be controlled by the pointing device. For another example, in a second mode, a selection bar may be displayed on the screen and be controlled through a simulated operation of arrow keys from the pointing device.

The electronic device 100 has a screen 110, a pointing device 120 and a processing module 130. The pointing device 120 may be an optical finger navigation device, a touchpad and etc. The pointing device 120 generates a control signal. Specifically, the pointing device 120 can be touched by a finger, and can generate the control signal based on the movement of the finger. The processing module 130 determines a present mode as a first mode or a second mode.

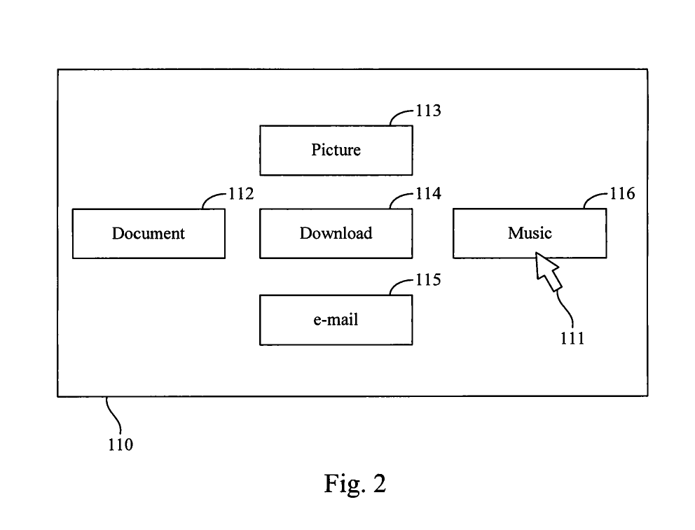

FIG. 2 is a front view of a screen 110 in a first mode according to the embodiment of the present invention. Please refer to FIG. 1 and FIG. 2 at the same time. When the present mode is the first mode, the processing module 130 moves the cursor 111 displayed on the screen 110 according to the control signal. Specifically, the processing module 130 has a converter 131 and a processor 132. The converter 131 is electrically connected to the processor 132. The converter 131 may be an embedded controller, a keyboard controller, a micro control unit and etc. In the first mode, the converter 131 forwards the control signal to the processor 132. Then, the processor 132 moves the cursor 111 according to the control signal.

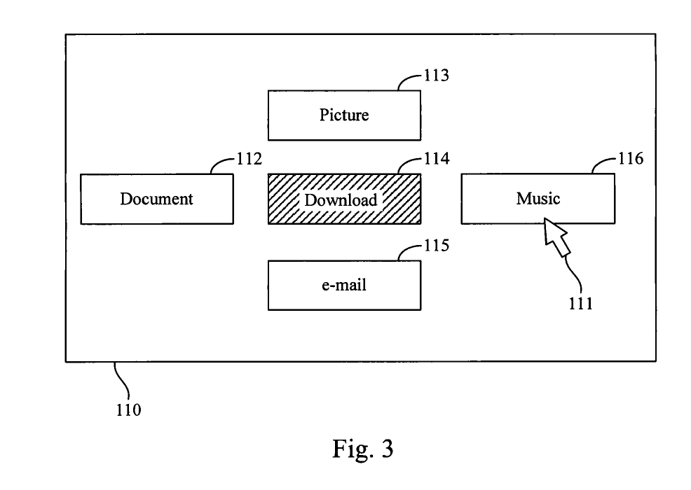

FIG. 3 is a front view of the screen 110 in a second mode according to the embodiment of the present invention. Several preset bars are displayed on the screen 110. The selection bar can be moved within the preset bars to allow the user to select one of them. In the embodiment of this invention, there are many preset bars like “document” 112, “picture” 113, “download” 114, “e-mail” 115 and “music” 116 displayed on the screen 110. The selection bar is now at the “download” 114, which is high-lined with oblique lines in the background. In other embodiments, the high-line of the selected bar may be designed as different patterns.

Reference is made to FIGS. 1 and 3. When the present mode is the second mode, the processing module 130 simulates an operation of several arrow keys to move the selection bar displayed on the screen 110 according to the control signal. In particular, the pointing device 120 generates control signals such as upward signals, downward signals, leftward signals and rightward signals according to the operation of the user. The pointing device 120 then forwards the control signals to the processing module 130. In other words, in the second mode, the operation of the user can be simulated as a press on the arrow key on a keyboard. The converter 131 of the processing module 130 converts the control signal into an arrow-key signal. The converter 131 may apply one of scan codes of the arrow keys to the arrow-key signal. For example, when the control signal is an upward signal, the converter 131 converts the control signal to a scan code of the upward arrow key. Then, the selection bar is moved upward to the “picture” 113 accordingly. When the control signal is a downward signal, the converter 131 converts the control signal to a scan code of the downward arrow key. Then, the selection bar is moved downward to the “e-mail” 115 accordingly. When the control signal is a leftward signal, the converter 131 converts the control signal to a scan code of the leftward arrow key. Then, the selection bar is moved leftward to the “document” 112 accordingly. When the control signal is a rightward signal, the converter 131 converts the control signal to a scan code of the rightward arrow key. Then, the selection bar is moved rightward to the “music” 116 accordingly.

The processor 132 moves the selection bar on the screen 110 according to the arrow-key signal. Therefore, the processor 132 can execute the operations respective to the arrow keys according to the scan codes.

Furthermore, the electronic device 100 has an arrow-control key 140. The arrow-control key 140 is connected to the processing module 130. When the arrow-control key 140 has been pressed, the processing module 130 determines whether a time period of the arrow-control key 140 being pressed is longer than a preset period. When the time period is longer than the preset period, the processing module 130 switches the present mode of the electronic device 110.

Reference is made to FIGS. 1 and 3. When the time period of the arrow-control key 140 being pressed is not longer than the preset period in the first mode, the processing module 130 performs a click on a position of the cursor 111. For example, in the embodiment, the processing module 130 may use the cursor 111 to click the “music” 116. Alternatively, please refer to FIG. 1 and FIG. 3. When the time period of the arrow-control key 140 being pressed is not longer than the preset period in the second mode, the processing module 130 performs an enter operation on a position of the selection bar. For example, in the embodiment, the processing module 130 may execute the function of the “download” 114.

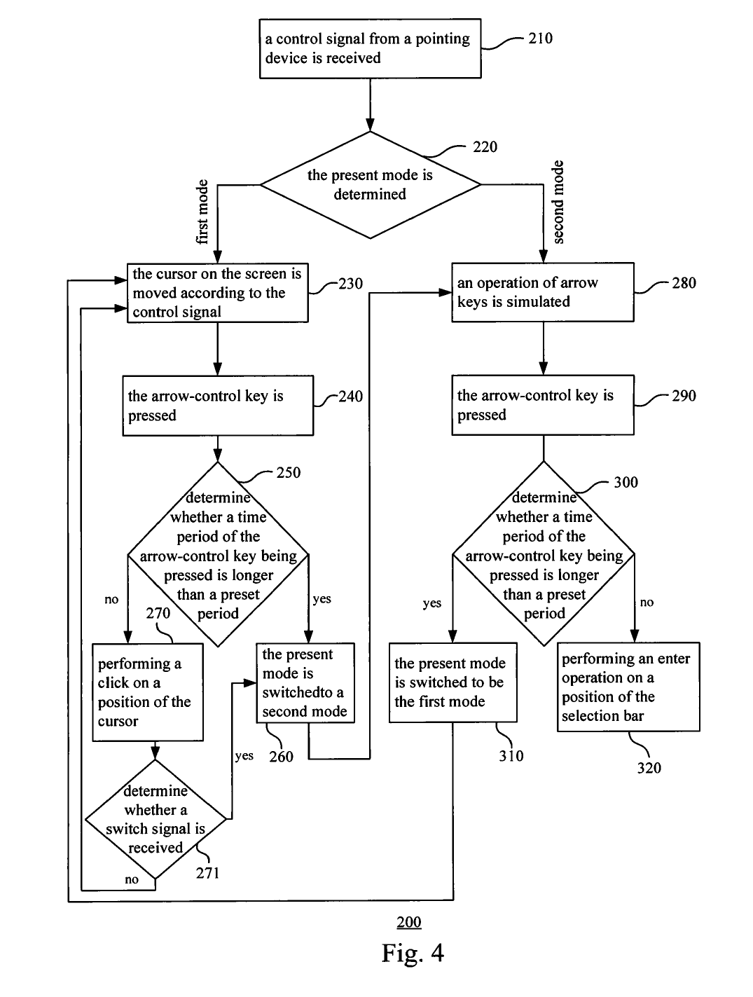

FIG. 4 is a flow diagram of an operation method 200 for a pointing device according to another embodiment of this invention. The operation method 200 allows the user to use the pointing device in several different modes. For example, in a first mode, the user can use the pointing device to move the cursor displayed on the screen. In a second mode, the user can use the simulated arrow keys to move the selection bar displayed on the screen. The operation method 200 can be applied to the electronic device with pointing device. The operation method 200 has several steps as follows.

In step 210, a control signal from a pointing device is received. A present mode is provided. Then, in step 220, the present mode is determined. The pointing device 120 may be an optical finger navigation device, a touchpad, and etc.

Reference is made to FIGS. 1 and 3. When the present mode is a first mode, the cursor 111 displayed on the screen 110 can be moved according to the control signal (step 230). Therefore, the user may instinctively use the pointing device.

Furthermore, when the user presses the arrow-control key (step 240), a time period of the arrow-control key being pressed is determined whether it is longer than a preset period (step 250). For example, the pointing device is an optical finger navigation device. An enter key on the optical finger navigation device can be applied to be the arrow-control key. The arrow-control key can be set below the pointing device. Alternatively, in other embodiments, different kinds of arrow-control keys can be used.

When the time period of the arrow-control key being pressed is longer than the preset period, a switch signal is generated. In step 260, the present mode is switched from the first mode to a second mode according to the switch signal. In the second mode, an operation of a plurality of arrow keys is simulated (step 280). Specifically, when the time period of the arrow-control key being pressed is longer than the preset period, the pointing device receives a continuous pressing signal. And then, the arrow-control key is triggered off to generate the switch signal. In the embodiment, the operation method 200 is applied to the electronic device 100 as illustrated in FIG. 1. The switch signal is forwarded to the processing module 130 in the step 260. After receiving the switch single, the processing module 130 switches the first mode to the second mode.

When the time period of the arrow-control key being pressed is not longer than the preset period, a click is performed on a position of the cursor 111 in the first mode (step 270). For example, the “music” 116 is clicked. Therefore, through the steps 240-270, the user can use a single key such as the arrow-control key to perform multiple functions, for example to switch the present mode and to perform a “click”.

Furthermore, in step 271, the processing module determines whether a switch signal is received. When no switch signal is received, the present mode remains to be the first mode, and the step 230 is then performed. Alternatively, when the switch signal is received, the present mode is switched to be the second mode (step 260).

In the second mode, an operation of the arrow keys is simulated according to the control signal (step 280). The simulated operation is used to move the selection bar within the preset bars displayed on the screen. For example, a press on an upward arrow key, a downward arrow key, a leftward arrow key and/or a rightward arrow key may be simulated according to the control signal. Please refer to FIG. 3. When the control signal is an upward signal, the press on the upward arrow key is simulated to move the selection bar on the screen 110 upward to the “picture” 113. When the control signal is a downward signal, the press on the downward arrow key is simulated to move the selection bar downward to the “e-mail” 115. When the control signal is a leftward signal, the press on the leftward arrow key is simulated to move the selection bar leftward to the “document” 112. When the control signal is a rightward signal, the press on the rightward arrow key is simulated to move the selection bar rightward to the “music” 116. In the step 280, the control signal is converted to an arrow-key signal. According to the arrow-key signal, the selection bar can be moved on the screen 110. Furthermore, the operation method 200 may be applied to a computer. The scan codes of the arrow keys of keyboards can be applied to be the arrow-key signal.

Please refer to FIG. 3 and FIG. 4 at the same time. When the arrow-control key is pressed (step 290), a time period of the arrow-control key being pressed is determined whether it is longer than a preset period (step 300). When the time period of the arrow-control key being pressed is longer than the preset period, another switch signal is generated. According to the switch signal, the present mode is switched to the first mode (step 310). And then, the step 230 may be performed. When the operation method 200 is applied to the electronic device 100 as illustrated in FIG. 1, the switch signal is forwarded to the processing module 130 in the step 310. After receiving the switch signal, the processing module 130 switches the second mode to the first mode.

When the time period of the arrow-control key being pressed is not longer than the preset period, an enter operation is performed on a position of the selection bar in the second mode (step 320). Therefore, the function of the selected bar is executed. Furthermore, the operation method 200 may be applied to a computer. The scan codes of the enter key of keyboards can be applied in the step 320.

In the foregoing, the electronic device with pointing device provides different operation modes. The user can use the pointing device to control the cursor or the selection bar in different modes. Furthermore, the user may press the arrow-control key longer to switch the modes. The user may also press the arrow-control key to perform a “click” or an “enter”. In short, the above functions, for example mode switching, the “click”, and the “enter”, can be performed through a single key.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An operation method for a pointing device, comprising:
providing a present mode;
determining whether a switch signal is received;
setting the present mode to a first mode when the switch signal is not received, wherein a cursor is displayed on a screen in the first mode;
moving the cursor according to a control signal generated from the pointing device in the first mode;
setting the present mode to a second mode when the switch signal is received, wherein a selection bar is displayed on the screen in the second mode; and
simulating an operation of a plurality of arrow keys to move the selection bar according to the control signal in the second mode.

2. The operation method for the pointing device of claim 1, wherein the arrow keys comprise an upward arrow key, a downward arrow key, a leftward arrow key and a rightward arrow key, and the step of simulating the operation of the arrow keys comprises:
simulating a press on the upward arrow key to move the selection bar upwards when the control signal is an upward signal;
simulating a press on the downward arrow key to move the selection bar downwards when the control signal is a downward signal;
simulating a press on the leftward arrow key to move the selection bar leftwards when the control signal is a leftward signal; and
simulating a press on the rightward arrow key to move the selection bar rightwards when the control signal is a rightward signal.

3. The operation method for the pointing device of claim 1, wherein the step of simulating the operation of the arrow keys comprises:
converting the control signal to an arrow-key signal, wherein one of scan codes of the arrow keys is applied to be the arrow-key signal; and
moving the selection bar according to the arrow-key signal.

4. The operation method for the pointing device of claim 1, further comprising:
switching the present mode when the switch signal is received.

5. The operation method for the pointing device of claim 4, further comprising:
determining whether a time period of an arrow-control key being pressed is longer than a preset period; and
generating the switch signal when the time period is longer than the preset period.

6. The operation method for the pointing device of claim 5, further comprising:
performing a click on a position of the cursor when the time period is not longer than the preset period in the first mode.

7. The operation method for the pointing device of claim 5, further comprising:
performing an enter operation on a position of the selection bar when the time period is not longer than the preset period in the second mode.

8. The operation method for the pointing device of claim 4, wherein the step of switching the present mode when the switch signal is received comprises:
switching the present mode from the first mode to the second mode when the present mode is the first mode; and
switching the present mode from the second mode to the first mode when the present mode is the second mode.

9. The operation method for the pointing device of claim 1, wherein the pointing device is an optical finger navigation device or a touchpad.

10. An electronic device, comprising:
a screen;
a pointing device for generating a control signal; and
a processing module for determining a present mode, wherein the processing module moves a cursor displayed on the screen according to the control signal when the present mode is in a first mode, and the processing module simulates an operation of a plurality of arrow keys to move a selection bar displayed on the screen according to the control signal when the present mode is in a second mode.

11. The electronic device of claim 10, wherein the processing module comprises:
a converter; and
a processor electrically connected to the converter, wherein the converter forwards the control signal to the processor and the processor moves the cursor according to the control signal when the present mode is in the first mode, and the converter converts the control signal into an arrow-key signal and the processor moves the selection bar according to the arrow-key signal when the present mode is in the second mode.

12. The electronic device of claim 11, wherein one of scan codes of the arrow keys is applied to be the arrow-key signal.

13. The electronic device of claim 10, further comprising:
an arrow-control key connected to the processing module, wherein the processing module determines whether a time period of the arrow-control key being pressed is longer than a preset period, the processing module switches the present mode when the time period is longer than the preset period, the processing module performs a click on a position of the cursor in the first mode when the time period is not longer than the preset period, and the processing module performs an enter operation on a position of the selection bar in the second mode when the time period is not longer than the preset period.

14. The electronic device of claim 10, wherein the pointing device is an optical finger navigation device or a touchpad.

15. An operation method for a pointing device of an electronic device, the electronic device comprising a screen, a processing module, a pointing device and an arrow-control key set below the pointing device, the operation method comprising:
executing a first mode;
moving a cursor displayed on the screen according to a control signal in the first mode when the pointing device receives the control signal;
triggering off the arrow-control key to generate a switch signal when the pointing device receives a continuous pressing signal;
forwarding the switch signal to the processing module to switch the first mode to a second mode; and
converting the control signal to a scan code to move a selection bar within a plurality of preset bars on the screen in the second mode.
